(19) United States
(12) Patent Application Publication
(10) Pub. No.: US 2025/0259564 A1
(43) Pub. Date: Aug. 14, 2025

(54) REUSABLE BREACHING TRAINING DOOR

(71) Applicant: San Hitech Ltd, Qiryat Shemona (IL)

(72) Inventors: Aviad BRILON, Matthews, NC (US); Damien LIESMAN, New London, NC (US)

(73) Assignee: San Hitech Ltd, Qiryat Shemona (IL)

(21) Appl. No.: 18/857,868

(22) PCT Filed: May 10, 2023
(86) PCT No.: PCT/IL2023/050480

§ 371 Date: Oct. 18, 2024

Related U.S. Application Data
(60) Provisional application No. 63/341,187, filed on May 12, 2022.

(51) Int. Cl. G09B 19/00; A62B 3/00

(52) U.S. Cl. CPC G09B 19/00; A62B 3/005

(57) ABSTRACT

Presented herein is a training apparatus designed for training first responders, law enforcement and military personal in the use of breaching tools. The training apparatus comprises: a door and a door frame. The door frame comprises an additional upright profile that functions as the door jamb located between a lock side upright of the door frame and a lock side rail of the door. The door jamb is supported by the door frame but not fixed directly to it at either the top or the bottom of the door jamb, thereby allowing the door jamb to move away from a lock side rail of the door during a breaching exercise. Also described herein are several add-on training assemblies that provide different realistic training scenarios.

### FIELD OF THE INVENTION

The invention is from the field of forced entry through doors. In particular, the invention relates to a reusable door and frame assembly designed for training first responders, law enforcement and military personnel in the use of breaching tools.

### BACKGROUND OF THE INVENTION

Breaching tools of many different types are standard equipment used by police, firefighters, and military personnel for forced entry into structures in the course of their operational duties. In order to maximize the efficiency of use of these tools and to decrease the time needed to force open doors, these personnel must be trained in their use. The doors used as training aids must be very robust to resist damage caused by the very large forces exerted on the doors and their frames by the breaching tools, especially when they are introduced into the space between the edges of the door and the door jamb.

U.S. Pat. No. 9,318,028 discloses a breaching training door assembly. A distinctive feature of this assembly is rubber mounts at the top and bottom of the upright door jamb that connect the door jamb to horizontal members at the top and bottom of the door frame. These rubber mounts are distorted when a breaching tool is inserted between the edge of a door and the door jamb, allowing the jamb to move sideward away from the door during the breaching operation. Another distinctive feature of the assembly is replaceable metal sleeves that cover and protect the edge of the door from damage caused by the breaching tools.

U.S. Pat. No. 8,926,332, which is a continuation of U.S. Pat. No. 8,408,917, discloses a training apparatus for forcible entry of a door using a prying tool such as a crowbar. The frame of the door is comprised of two vertical members called door stop jamb and hinge jamb located on either side of the door. The two jambs are mounted on a base and connected at the top by a horizontal member. The distinguishing feature of this apparatus is that the door hinges are mounted to the hinge jamb in a manner that allows sliding motion toward and away from an inner surface of the hinge jamb, and the hinges include springs that bias the sliding hinges away from the hinge jamb and which resist compression with sufficient force to simulate forces that are encountered when attempting to wedge a pry tool between the door and the door stop jamb.

It is a purpose of the present invention to provide a robust assembly for use in training defense and rescue forces to breach doors in the most realistic way, with maximum efficiency and speed.

Further purposes and advantages of this invention will appear as the description proceeds.

### SUMMARY OF THE INVENTION

Disclosed herein is a training apparatus configured for training personnel in the skills necessary for breaching doors using breaching tools. The training apparatus comprises: a door and a door frame.

The door is comprised of two horizontal lengths and two vertical lengths of hollow steel profile welded at their corners to form a rectangle, wherein the profiles of the door are identified as follows: hinge side rail, lock side rail, bottom rail, and top rail.

The door frame is comprised of two horizontal and two vertical lengths of hollow steel profile welded at their corners to form a rectangle, wherein the profiles of the door frame are identified as follows: hinge side upright, lock side upright, sill, and header.

The hinge side rail of the door is connected to the hinge side upright of the door frame by hinges allowing the door to swing open or closed inside the frame.

The training apparatus is characterized in that the door frame comprises an additional upright profile that functions as the door jamb located between the lock side upright of the door frame and the lock side rail of the door. The door jamb is supported by the door frame but not fixed directly to the door frame at either the header or the sill, and the top and bottom of the door jamb are free to move sideways, forward, and backward within confined spaces attached respectively to the header and the sill of the door frame, in order to allow the door jamb to move away from the lock side rail of the door during a breaching exercise.

In embodiments of the training apparatus:
a) the jamb comprises:
   i) a projecting tab or pin at the top and bottom; and
   ii) a bracket below the tab or pin at the top and bottom;
b) the door frame comprises:
   i) a box attached to the header and a box attached to the sill;
   ii) a recess in each box;
   iii) spring holders attached near the top and bottom of the lock side upright; and
   iv) springs in the spring holders;
c) the projecting tabs or pins at the top and bottom of the jamb fit loosely into the recesses, thereby allowing the top and bottom of the jamb to move sideways, forward, and backward within the recesses; the springs butt against the brackets to push the jamb against the lock side rail of the door and to maintain counter pressure against the lock side rail and a breaching tool when attempting to move the jamb away from the lock side rail of the door during a breaching exercise; and
d) the springs can be easily replaced to provide springs that have different amounts of resistance to compression to provide different levels of difficulty during training.

Embodiments of the training apparatus comprise multiple holes drilled through the jamb and corresponding holes drilled through the lock side rail of the door. The holes are configured to allow insertion of pins that simulate multiple locking locations.

Embodiments of the training apparatus comprise replaceable sleeves in at least one of the holes through the jamb and the lock side rail of the door.

In embodiments of the training apparatus the replaceable sleeves have hexagonal heads.

Embodiments of the training apparatus comprise at least one of the following training assemblies: a) a gate; b) a flip up flange assembly; and c) a zero gap door assembly.

In embodiments of the training apparatus the gate is configured to train personnel to use various types of tools designed for cutting metal bars, chains, chain link fence, and padlocks.

In embodiments of the training apparatus the gate comprises a wood plank configured to allow the training apparatus to be used for training in ballistic breaching.

In embodiments of the training apparatus the door comprises a metal plate configured to allow the training apparatus to be used for training in mechanical or explosive breaching.

In embodiments of the training apparatus the flip up flange assembly is configured for training in the use of a breaching tool for breaching doors that comprise a flange that covers a gap between the door and the jamb.

In embodiments of the training apparatus the flip up flange assembly comprises:
a) a replaceable piece of sheet metal having a portion that simulates the edge of a real door that overhangs the jamb; and
b) springs that exert a force that pushes the portion of replaceable sheet metal firmly against the top of the jamb, wherein the springs can be easily replaced to provide springs that have different amounts of resistance to compression to provide different levels of difficulty during training.

In embodiments of the flip up flange assembly the replaceable piece of sheet metal is sandwiched between a metal plate and a front side of a front wall of the flip up flange assembly and the metal plate and sheet metal are bolted to the front wall.

In these embodiments of the training apparatus during a breaching exercise the breaching tool is inserted between the bottom of the portion of the sheet metal and the top of the jamb and during the procedure the breaching tool overcomes the force exerted by the springs, thereby forcing the portion of sheet metal to pivot upwards separating the door from the jamb.

In embodiments of the training apparatus the zero gap door assembly is configured for training in the use of a breaching tool for breaching a door, which abuts the frame and is locked to the frame by means of a key activated lock bolt.

In embodiments of the training apparatus the zero gap door assembly comprises:
a) a cassette subassembly; and
b) a jamb subassembly.

In embodiments of the training apparatus:
a) the cassette subassembly comprises:
   i) a frame configured to be attached to the lock side rail of the door;
   ii) a cassette filled with a wood insert comprised of one or more pieces of wood;
   iii) a lock body installed in the wood insert;
   iv) a face plate inserted on the edge of the wood insert that faces the jamb;
   v) a lock bolt configured to extend outwards through the face plate or retract back into the wood insert;
   vi) multiple springs configured to push the cassette towards the jamb and to provide resistance as the cassette is forced to slide into the frame away from the jamb during a breaching exercise, wherein the springs can be easily replaced to provide springs that have different amounts of resistance to compression to provide different levels of difficulty during training;
b) the jamb subassembly comprises:
   i) a frame configured to be attached to a side of the jamb;
   ii) a wood insert configured to fit into the frame such that one edge of the wood insert faces the face plate on the wood insert in the cassette subassembly;
   iii) a strike plate and hole configured to receive the lock bolt that extends from the face plate of the cassette subassembly to lock the two subassemblies together.

In embodiments of the training apparatus the wood inserts in at least one of the cassette subassembly or the jamb subassembly are replaceable if damaged.

In embodiments of the training apparatus comprising a zero gap door assembly during a breaching training exercise, with the two subassemblies locked together, a breaching tool is inserted between the wood insert in the cassette subassembly and the jamb assembly and activated, whereupon the force exerted by the breaching tool overcomes the force exerted by the springs thereby compressing the springs and pushing the cassette into the frame until the lock bolt is pulled out of the strike plate allowing the door to be separated from the jamb.

Embodiments of the training apparatus comprise a support structure configured to minimize interference with the activities of trainees during a breaching training session.

All the above and other characteristics and advantages of the invention will be further understood through the following illustrative and non-limitative description of embodiments thereof, with reference to the appended drawings.

### BRIEF DESCRIPTION OF THE DRAWINGS

FIGS. 1A and 1B are overall views showing the training apparatus of the invention from the side of the apparatus approached by the operator of the breaching tool and the opposite side of the apparatus respectively;

FIG. 1C shows the training apparatus 10 from the side of the apparatus approached by a trainee with the door 12 locked into the door frame;

FIGS. 2A and 2B show the door frame of the apparatus of FIGS. 1A, 1B, and 1C from the side of the apparatus approached by the operator of the breaching tool and the opposite side of the apparatus respectively;

FIG. 2C shows the door frame 12 from the side of the apparatus approached by a trainee;

FIGS. 3A and 3B show the door of the apparatus of FIGS. 1A, 1B, and 1C from the side of the apparatus approached by the operator of the breaching tool and the opposite side of the apparatus respectively;

FIG. 3C shows the door 14 from the side of the apparatus approached by a trainee;

FIGS. 4A and 4B show the door jamb of the apparatus of FIGS. 1A, 1B, and 1C from the side of the apparatus approached by the operator of the breaching tool and the opposite side of the apparatus respectively;

FIG. 5 shows a sleeve for insertion of a locking pin;

FIG. 6 shows a gate, which is an optional feature of the training apparatus of FIGS. 1A, 1B, and 1C;

FIGS. 7A and 7B are photographs showing two views of a hydraulic door breaker tool;

FIGS. 8A and 8B show two views of an assembly comprising a flip up flange;

FIG. 8C shows a different embodiment of the flip up flange assembly of FIG. 8A and FIG. 8B;

FIG. 8D and FIG. 8E show respectively back and front views of the front part of the flip up flange assembly of FIG. 8C;

FIGS. 9A to 9D are screenshots showing different stages of a breaching procedure carried out using the door breaker tool of FIGS. 7A and 7B on the training apparatus of FIGS. 1A and 1B comprising an assembly of FIGS. 8A and 8B;

FIGS. 10A and 10B show a cassette subassembly of an assembly configured to simulate a zero gap door;

FIGS. 11A and 11B show a jamb subassembly of an assembly configured to simulate a zero gap door; and

FIGS. 12A to 12D are screenshots showing different stages of a breaching procedure carried out using the door breaker tool of FIGS. 7A and 7B on the training apparatus of FIGS. 1A and 1B comprising an assembly composed of the subassemblies FIGS. 10A to 11B.

### DETAILED DESCRIPTION OF EMBODIMENTS OF THE INVENTION

Presented herein is a training apparatus comprised of a door frame and a door that is attached to the frame by hinges. Three different training assemblies can be attached to the frame or door that are designed for training military, police, and fire personnel in the skills necessary for breaching doors using different types of breaching tools that can be used to perform methods of manual breeching, mechanical breaching, ballistic breaching, hydraulic breaching, and explosive breaching. In order to accomplish its purpose, the apparatus must, on the one hand, be configured to present the trainees with as many different scenarios as they are likely to encounter in the field and, on the other hand, be robust enough to be used repeatedly with minimal damage.

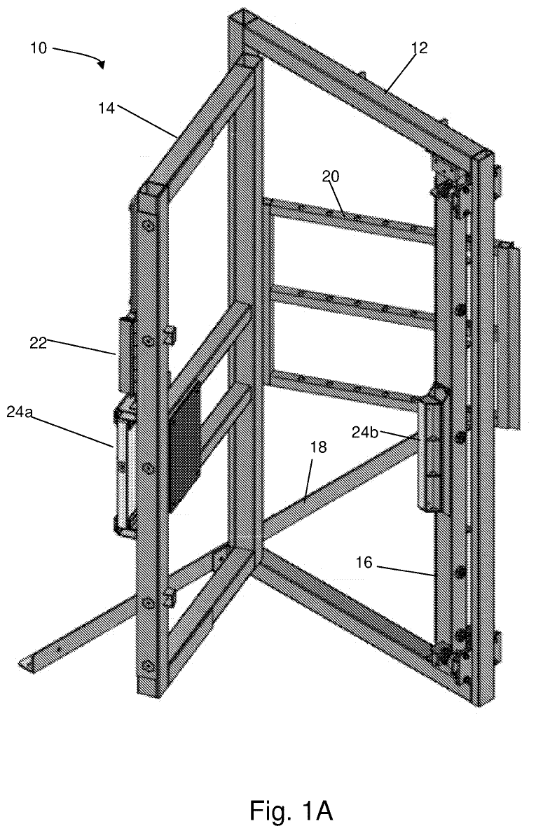

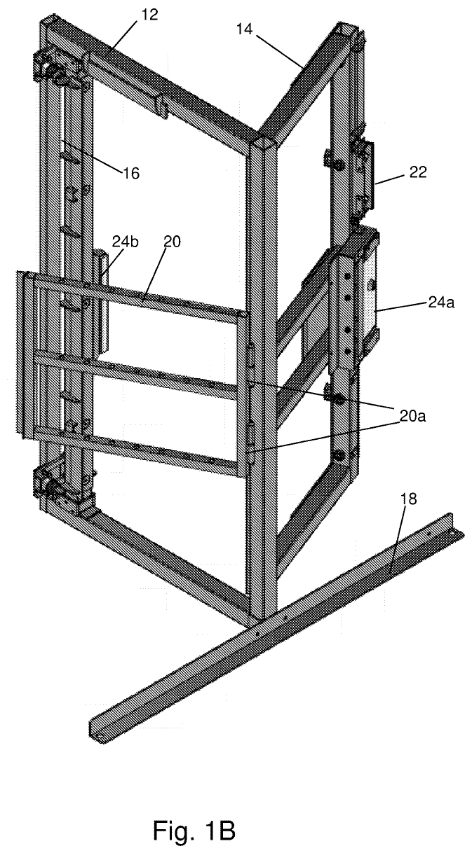

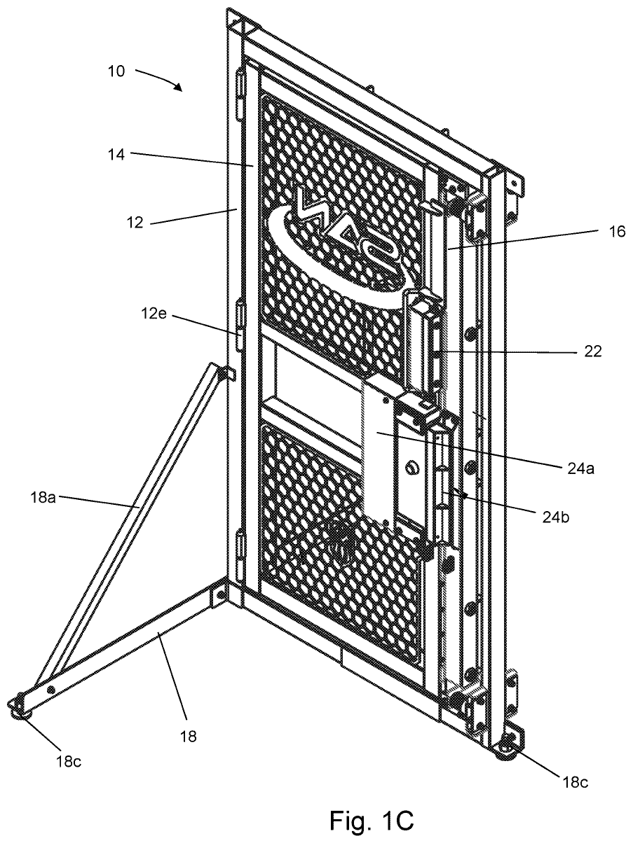

FIGS. 1A and 1B show the training apparatus 10 from the side of the apparatus approached by the operator of the breaching tool and the opposite side respectively. Herein the type of the door is defined by the way it is swung open in order to gain entrance into the stronghold i.e., house, room, compound etc. During a breaching exercise using training apparatus 10, an “inwards opening” door is pushed inwards away from the operator of the breaching tool and an “outwards opening” door is pulled outwards towards the operator in order to go through it. The training apparatus 10 can be used to train on both sides, i.e. the push or the pull side. FIG. 1C shows the training apparatus 10 from the side of the apparatus approached by a trainee with the door 12 locked into the door frame.

Training apparatus 10 is comprised of a door frame 12, a door 14 and a “floating” jamb 16, which is interposed between the door 14 and the door frame 12. Jamb 16 is supported by door frame 12 but not fixed directly to the door frame 12. The embodiment of training apparatus 10 described herein is configured such that door 14, which is connected to door frame 12 by hinges 20a (see FIG. 1C and note that two, three, or more hinges can be used) is able to swing open only in the outward direction away from door frame 12.

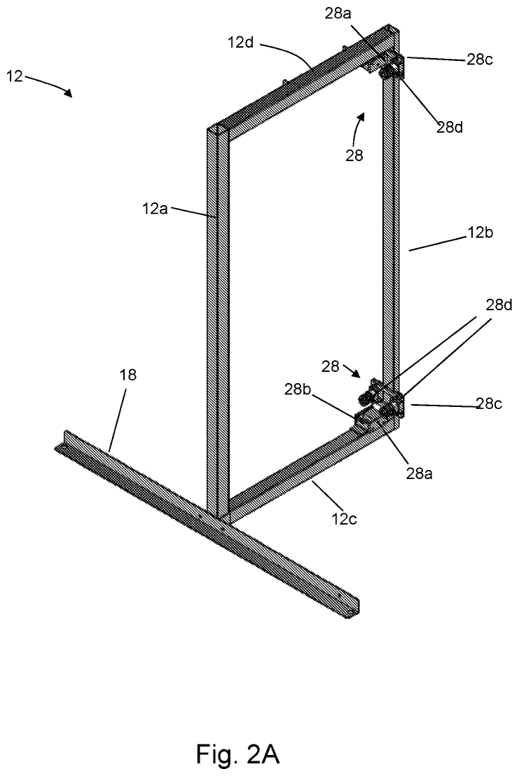

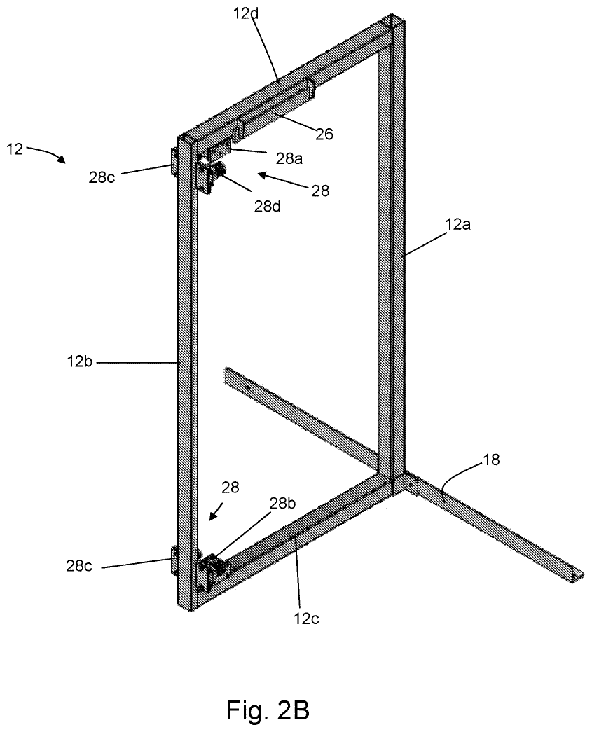

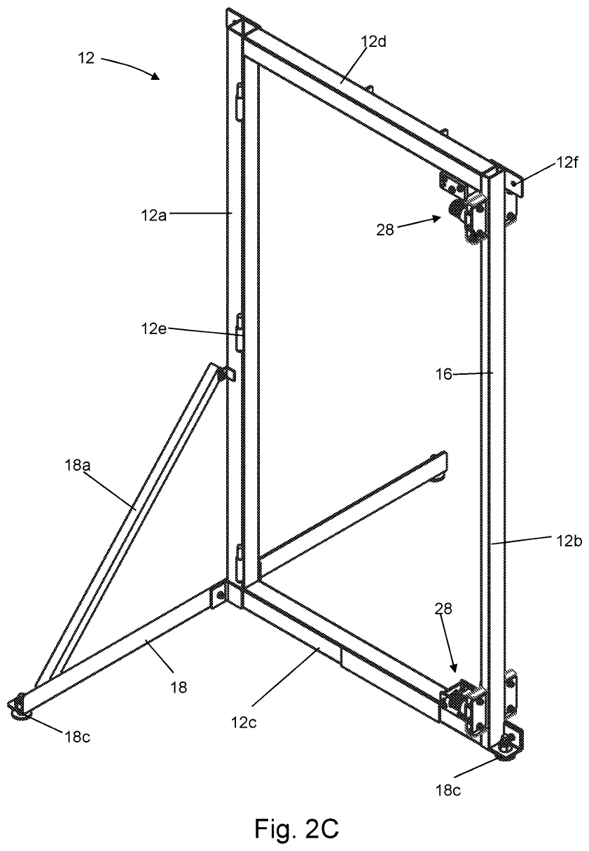

Training apparatus 10 is stable enough to normally remain upright during all training exercises; however, if located on an unlevel floor or ground, supports can be added to stabilize apparatus 10. One possible embodiment of a support structure is shown in FIGS. 1A and 1B. The support structure should be designed to minimize interference with the activities of the trainees during a breaching training session. Therefore in this embodiment, the corner on the lock side of door frame 12 rests on the floor and a length of angle iron 18, which is lying on the floor, is attached to the bottom corner at the hinge side of the door frame 12 in a direction perpendicular to the plane of frame 12. Levelling screws can be included at both ends of the angle iron 18. In addition, as shown in FIG. 1C and FIG. 2C, at least one strut 18a can be added with its top end fastened to the hinge side upright of door frame 12 and its bottom end fastened to angle iron 18 and an additional leveling screw 18c can be added to a flange attached to the bottom of the lock side upright of door frame 12. The angle iron 18 and any added struts 18a are attached to frame 12 using bolts that can be removed for relocating apparatus 10. Operation of apparatus 10 is not limited by the use of a support structure and specifically not by the embodiment of support structure described herein.

Three optional training assemblies are shown attached to the door frame 12, to the door 14, or jamb 16 as shown in FIGS. 1A and 1B. These training assemblies are not necessarily components of all embodiments of training apparatus 10. Each of them is designed for training operators for a specific skill and they can be attached to apparatus 10 when one or more of these skills are being learned. The training assemblies shown are: gate 20, which is attached to the hinge side upright of the door frame 12; flip up flange assembly 22, which is attached to the lock side of door 14; and zero gap door assembly 24, which is comprised of two components: a cassette subassembly 24a attached to the lock side of the door and a jamb subassembly 24b attached to the jamb. These training assemblies will be described in detail herein below.

FIGS. 2A and 2B show door frame 12 from the side of door frame 12 approached by the operator of the breaching tool and the opposite side respectively. FIG. 2C shows the door frame 12 from the side of the apparatus approached by a trainee. Seen in FIG. 2B is a flat plate 26 of steel that is welded to the lock side half of header 12d at the top of door frame 12. Plate 26 is design to simulate a regular door frame so that trainees will be able to insert a breaching tool in the gap between top rail 14d of the door and plate 26 for an upside breaching exercise. Seen in the upper and lower corners at the intersection of header 12d and sill 12c with the lock side rail 12b of frame 12 are assemblies 28 configured for supporting the top and bottom of jamb 16 inside door frame 12. Additional features seen in the embodiment of FIG. 2C are: strut 18a, levelling screws 18c and flanges 12f added to both ends of header 12d to allow the frame to be attached to a wall or other structure.

Assembly 28 comprises a box 28a attached, e.g. bolted or welded, to the header 12d and sill 12c. Box 28a defines a cavity 28b into which the top and bottom ends of jamb 16 loosely fit. Assembly 28 also comprises spring holders 28c attached to lock side upright 12b of frame 12. Spring holders 28c are configured to support two springs 28d horizontally.

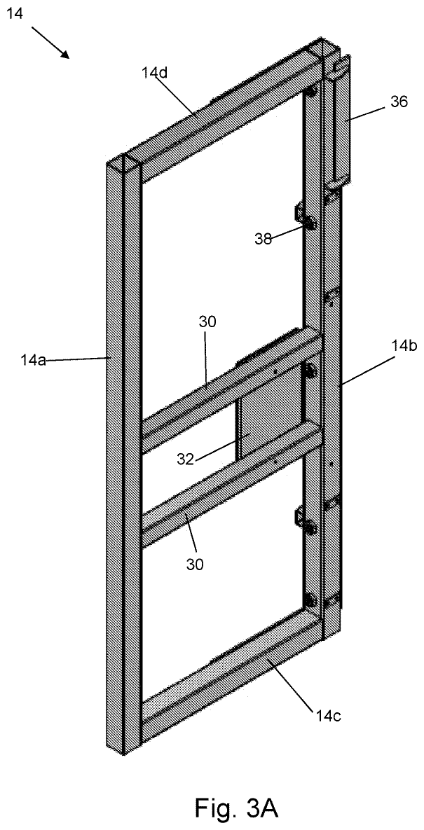

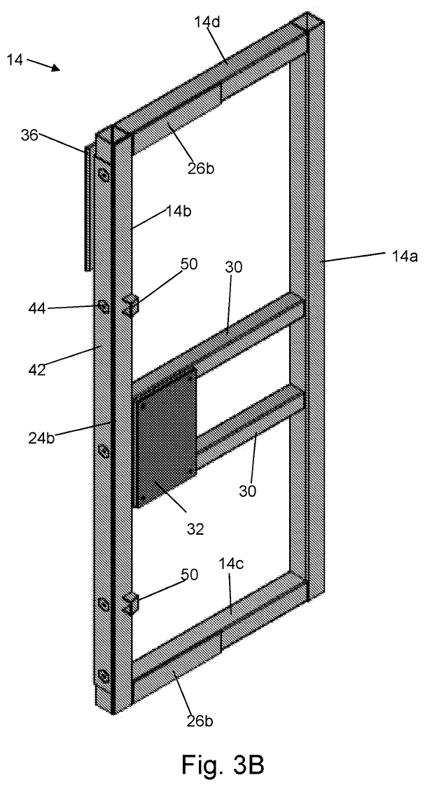

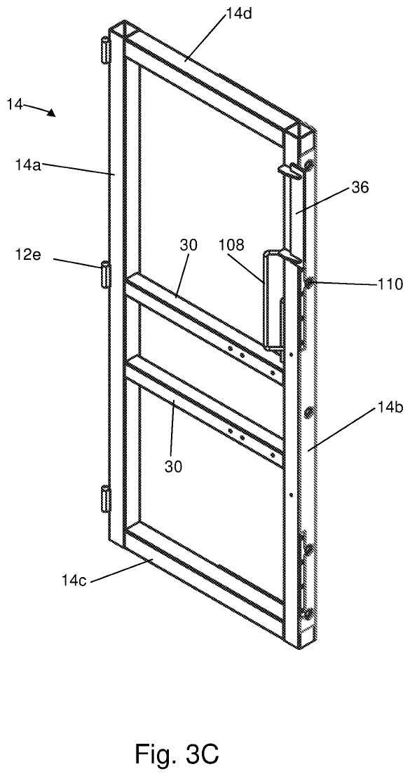

FIGS. 3A and 3B show door 14 from the side of the apparatus approached by the operator of the breaching tool and the opposite side respectively. FIG. 3C shows the door 14 from the side of the apparatus approached by a trainee. Door 14 is composed of two horizontal and two vertical lengths of hollow steel profile welded at their corners to form a rectangle. In the figures the profiles of door 14 are identified as follows: hinge side rail 14a, lock side rail 14b, bottom rail 14c, and top rail 14d. Steel plates 26b are welded to the inside of the lock sides of bottom rail 14c and top rail 14d to reinforce them when breaching operations are carried out. A flat steel plate 36 is welded to the top inside of lock side rail 14b to simulate a flange on the lock side edge of a conventional door. Plate 36 is used to train operators in using a breaching tool near the top of an outward opening door. In the middle of door 14 are two horizontal profiles 30 and a square metal plate 32 that are present to add additions rigidity and strength to the door for using mechanical tools in breaching exercises and to provide structural elements to which components of zero gap door assembly 24 can be attached. Additional features seen in the embodiment of FIG. 3C are: holes 110, hinges 12e, and door handle 108, which has been added for convenience and to simulate a feature of a real door.

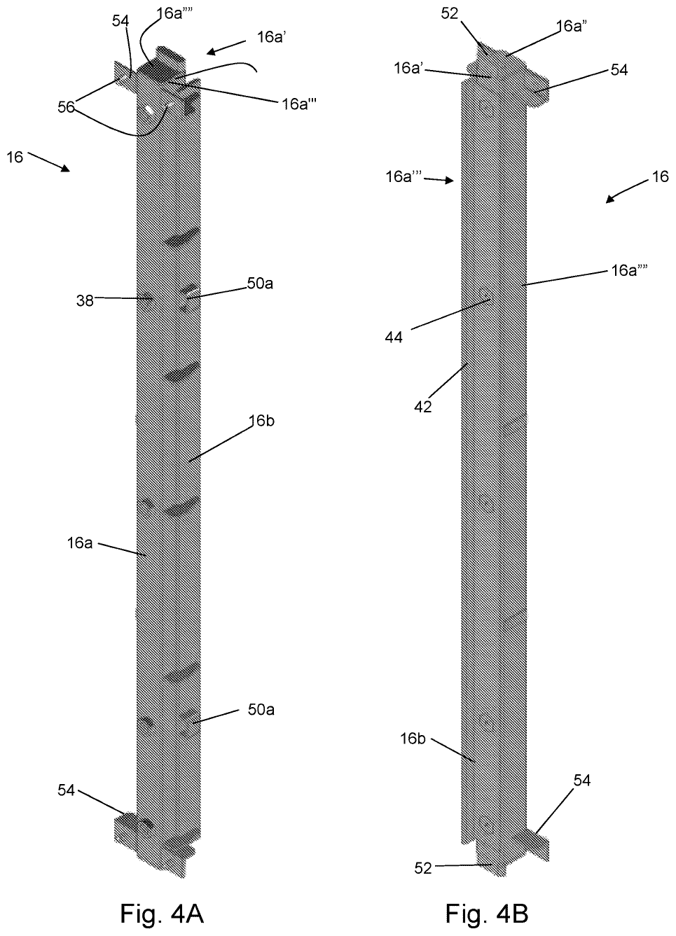

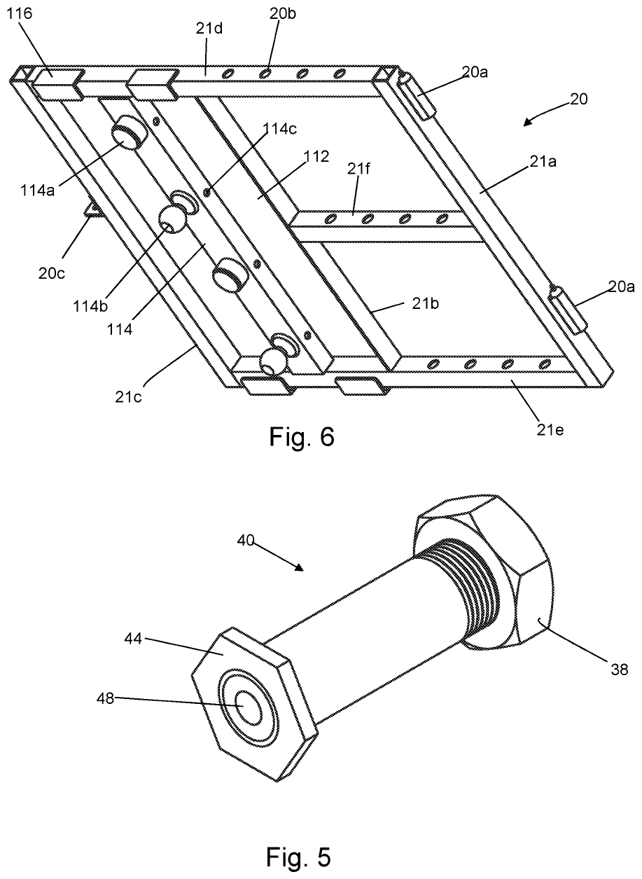

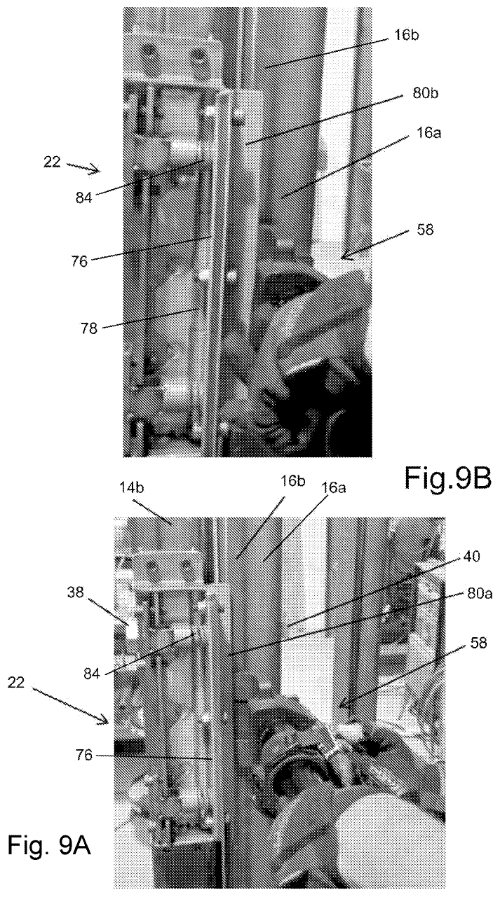

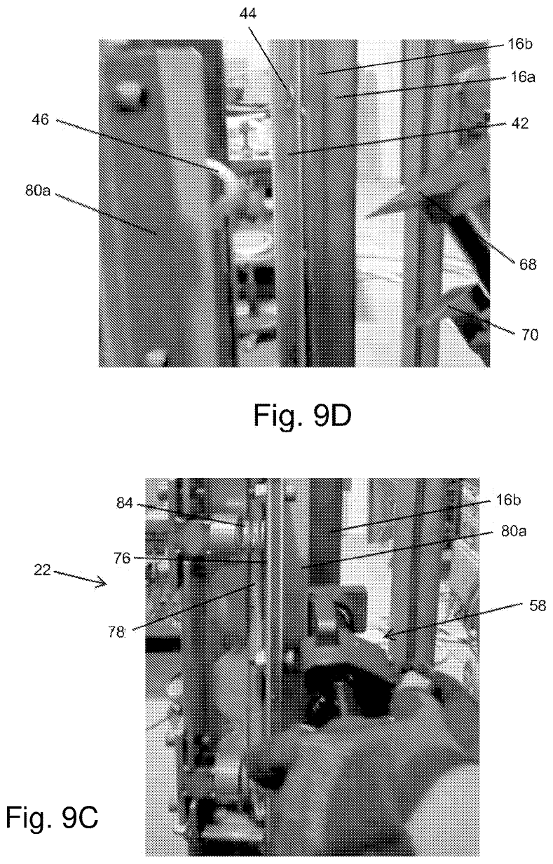

Seen in FIG. 3A are a plurality of nuts 38 that are attached to threaded ends of sleeves 40 (see FIG. 5) that project through lock side rail 14b of door 14. Holes 110 through which the sleeves 40 pass are drilled through the lock side rail 14b at various heights in order to simulate multiple locking locations that have to be ruptured to successfully breach the door. The holes 110 are located opposite similar holes 110 that are drilled through the jamb 16 (see FIGS. 4A and 4B). The sleeves 40 have a circular channel 48 (see FIG. 5) that passes through their interiors. Pins 46 (see FIG. 9D) that simulate locking or dead bolts between the door 14 and the jamb 16 can be inserted through channels 48. Although the figures show sleeves 40 in five holes 110 in lock side rail 14b, in different embodiments, more or fewer holes 110 may be provided and, in different training scenarios, only one or more sleeves may be used and/or only one or more pins 46 inserted through the sleeves. In FIG. 3B can be seen a strip 42 of steel that is welded on the face of lock side rail 14b that faces jamb 16. Strip 42 comprises a plurality of hexagonal sockets into which hexagonal heads 44 of sleeves 40 fit in order to allow smooth closing of the door 14 against the jamb 16 and to prevent damage to the breaching tools caused by the heads of the sleeves if they were to project out of the profiles. The pins 46 are made of different materials depending on the degree of difficulty planned for the breaching exercise. Materials used for the pins 46 include wood, aluminum, and iron or steel of various degrees of hardness. The sleeves 40 are provided because, in exercises employing hard metal pins 46 that didn't comprise sleeves 40, it was found that the force exerted on the pins 46 during breaching exercises causes damage to the holes 110 through the lock side rail 14b and jamb 16. Over the course of many training sessions the damage accrues until replacement of the lock side rail 14b and/or the jamb 16 becomes necessary. The use of replaceable sleeves 40 has eliminated the need for these costly and time consuming replacements. Further, since the damage caused by the pins 46 being pulled out of the sleeves 40 during a breaching operation is restricted to the side of the interior of sleeve 40 and head 44 in lock side rail 14b that faces the jamb 16 (and vice versa) the sleeves 40 have been designed with hexagonal heads 44. Thus, when, after many uses, one facet of head 44 is damaged then the nut 38 can be loosened or removed and the sleeve 40 rotated to expose the next facet. In this way the sleeve 40 can be reused many times on six different facets of its head 44 before it has to be discarded and replaced with a new sleeve 40.

Seen in FIG. 3B are staples 50 on lock side rail 14b. These are located opposite similar staples 50a (see FIG. 4A) on the jamb 16. A piece of metal or wood can be inserted between the matching staples 50 on the door 14 and staples 50a on jamb 16 to create closer contact between the door and the frame and to simulate a locking arrangement, e.g. a hasp or bolt of a lock.

FIGS. 4A and 4B show the door jamb 16 from the side of the apparatus approached by the operator of the breaching tool and the opposite side of the apparatus respectively. The door jamb 16 is an additional upright profile located between lock side upright 12b of frame 12 and lock side rail 14b of door 14. Jamb 16 is supported by door frame 12; but it is not fixed directly to either header 12d or sill 12c. As will be described below, the top and bottom of jamb 16 are free to float, i.e. move sideways and forward and backward, within confined spaces in order to allow jamb 16 to move away from lock side rail 14b of door 14 during a breaching exercise without causing damage that would occur in an actual breaching action to jamb 16 or lock side rail 14b.

Jamb 16 is comprised of a length of hollow steel square profile 16a. A first side 16a′ of profile 16a faces lock side rail 14b of door 14; an opposite side 16a″ of profile 16a faces lock side upright 12b of frame 12; a third side 16a′″ of profile 16 faces the push side of the door; and a fourth side 16a″″ is opposite side 16a′″ and the pull side of the door. A narrow flat strip 16b of steel is welded on the third side 16a′″ of the profile 16a. Strip of steel 16b overhangs the side 16a′″ of the profile 16a on the side of the lock side rail 14b of the door and the lock side upright 14b of door 14 mimicking a flange covering the gap between the door and door jamb in real frames doors.

As discussed above, holes 110 through which sleeves 40 pass are drilled at various heights through the sides 16a′ and 16a″ of profile 16a of jamb 16 in order to simulate multiple locking locations that have to be ruptured to successfully breach the door. Seen in FIG. 4A are the nuts 38 that are attached to threaded ends of sleeves 40 (see FIG. 5) that project through side 16a″ of profile 16a. In FIG. 4B is seen a strip 42 of steel that is welded on the side 16a′ of profile 16a of jamb 16. Strip 42 comprises a plurality of hexagonal sockets into which hexagonal heads 44 of sleeves 40 fit in order to allow smooth closing of the door 14 against the jamb 16. In FIG. 4A are seen staples 50a that correspond to those on lock side rail 14b described above.

At the top and bottom of profile 16a is a projecting tab 52. These tabs 52 can be formed by welding a piece of angle iron to the top and bottom of profile 16a as shown or alternately by machining the ends of the profile such that side 16a′ of profile 16a is longer than the other three sides of the profile. In other embodiments short pins project from the top and bottom of profile 16a may replace tabs 52. Also attached to sides 16a′″ and 16a″″ at the top and bottom of profile 16a are brackets 54 comprising pieces of right angle profile attached such that one face of the brackets 54 lies in a plane parallel to side 16a″ of profile 16a.

The tabs 52 at the top and bottom of the profile 16a of jamb 16 fit into cavities 28b in boxes 28a of the assemblies 28 at the top and bottom of door frame 12. Cavities 28b are large enough to allow tabs 52 to move within them both forward and backward and sideways relative to frame 12 while still being supported by frame 12 when a tool is used to force the door 14 and jamb 16 apart. Allowing jamb 16 to move in cavities 28b protects the jamb 16 from being bent permanently while simulating a scenario of breaching a real door in which the door jamb 16 would become distorted during the breaching process.

Springs 28d of assembly 28 butt against brackets 54 on profile 16a in order to push side 16a′ of profile 16a of jamb 16 against lock side rail 14b of the door. By pushing against the top and bottom of jamb 16 springs 28d maintain counter pressure against the lock side rail 14b of the door and a breaching tool, thereby increasing the difficulty level of inserting the tool in the gap between the jamb 16 and lock side rail 14b. To create different levels of difficulty, springs 28d can be replaced with springs having different resistances to compressive forces attempting to move the jamb 16 in cavities 28b. Another function of springs 28d is to return the jamb 16 against the door 14 if the tool slips out of the gap, which is a common problem in breaching actions that trainees have to learn to overcome. Holes 56 in brackets 54 accommodate bolts or pins that are inserted into the center of springs 28d in order to stabilize their contact with the jamb 16 and prevent any possible slippage of springs 28d on brackets 54 during compression of the springs during the breaching process.

FIG. 5 shows a sleeve 40 that has been described herein above. Sleeve 40 is dimensioned to be inserted into a hole 110 drilled through the jamb 16 of a door frame 12 and the lock side rail 14b of a door 14. Sleeves 40 are cylindrical pieces of metal having a head 44 larger than the diameter of the holes 110 in the door and jamb at one end and threads at the other end. A circular channel 48 for inserting the pins 46 (see FIG. 9D) passes through the center of sleeve 40. A sleeve 40 is slid through the hole until the head 44 butts against the side of the jamb 16 facing lock side rail 14b (or vice versa) and a nut 38 is threaded unto the threaded end of the sleeve 40 to hold it firmly in place.

FIG. 6 shows a different embodiment of the gate 20, which is shown in FIGS. 1A and 1B. The gate 20 is an optional feature of training apparatus 10. Gate 20 is a training assembly for training personnel to use various types of breeching tools. Gate 20 is connected by hinges 20a to the hinge side upright 12a of the door frame 12 (see FIG. 1B). Gate 20 is constructed from three vertical lengths 21a-21c, two horizontal lengths 21d and 21e of steel profile welded together to have a square or rectangular shape. A third horizontal length 21f is welded between vertical lengths 21a and 21b. A plurality of holes 20b in the horizontal profiles allow replaceable bars or rods of different types, strengths, and cross-sectional dimensions of metal or wood to be inserted to allow for training with cutting tools, e.g. manual or hydraulic bolt cutters. Also chains and pieces of chain link fence can be hung on gate 20 for training with the use of cutting tools. A flange 20c on the vertical profile opposite the hinges 20a can be configured to be locked to the door 14 by a padlock.

A wooden plank 112 is inserted into the gate 20 between vertical profiles 21b and 21c and held in place by brackets 116. The purpose of wooden plank 112 is to allow training in ballistic breaching using, for example, a shotgun.

For other exercises a metal plate 32 is bolted to horizontal profiles 30 and allows training in mechanical breaching using tools like sledgehammers, pry bars, or battering rams to breach a door. Because metal plate 32 is bolted, not welded, to horizontal profiles 30, it can be replaced with a new metal plate if bent or damaged beyond functionality during training. To minimize bending of the metal plate 32 caused by repeated breaching sessions using sledgehammers or rams, a covering of conveyor belt material or similar material is bolted to the side of the metal plate facing the trainee. This reduces the frequency with which the plate has to be replaced.

Additionally, training in explosive breaching can be done with small charges attached to a bare metal plate 32 or to lock side rail 14b of the door. Kinetic charges that will push and not cut the metal are used in these training sessions.

A vertical steel U-shaped profile 114 is added to the gate 20 for use with the wooden plank 112. Several disks 114a and trailer hitches 114b are attached to bar 114 to respectively simulate cylinder locks and door knobs. This is used to teach trainees the proper location at which to aim the shotgun for most effective breaching. Holes 114c are drilled horizontally through both sides of vertical profile 114 directly behind the disks 114a and trailer hitches 114b. Wooden dowels (not shown in the figure) can be inserted through the holes 114c protruding a few inches beyond each side of the vertical steel profile 114. These wooden dowels mimic the latch of a cylinder lock or the bolt of a dead bolt behind the disks 114a and trailer hitches 114b respectively. When a trainee aims the shotgun correctly, and shoots against the wooden plank 112, the shot penetrates wooden plank 112 and breaks the wooden dowel. If the trainee aims the shotgun incorrectly, the wooden dowel will remain intact, thus giving immediate feedback to a trainee's technique and accuracy.

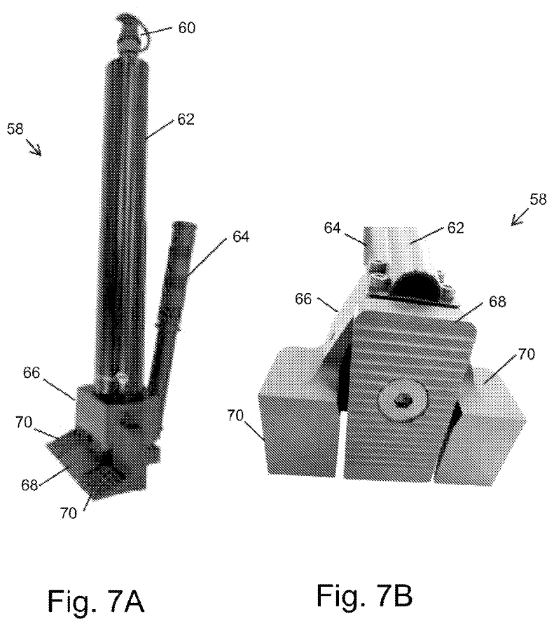

FIGS. 1A and 1B show two other training assemblies that can be added or removed from the apparatus depending on the requirements of a training session. Flip up flange assembly 22 is configured for training in the use of a breaching tool for breaching an ordinary door that has a flange that covers a gap between the door and the jamb. Zero gap door assembly 24 is configured for training in the use of a breaching tool for breaching a zero gap door, i.e. a door in which the door abuts the frame and the door is locked to the frame by means of a conventional key activated lock bolt. Both of these assemblies are configured to train individuals to breach different types of doors using different types of powered, i.e. hydraulic, pneumatic, electric, or manual, e.g. ram, sledge hammer, and pry bar, breaching tools. Below, following the description of each of these assemblies, the process of breaching the training apparatus 10 will be illustrated using the hydraulic door breaker tool manufactured by the Applicant of the present application, which is shown in FIGS. 7A and 7B.

FIGS. 7A and 7b are photographs showing two views of a hydraulic door breaker tool 58. Tool 58 comprises connector 60 to a manual or battery powered hydraulic pump, a piston cylinder 62, a handle 64, static teeth assembly/base 66, and three wedge shaped teeth best seen in FIG. 7B. Two of the teeth 70 are static teeth fixed to base 66. When the hydraulic pump is activated the dynamic middle tooth 68 is advanced forward out of base 66.

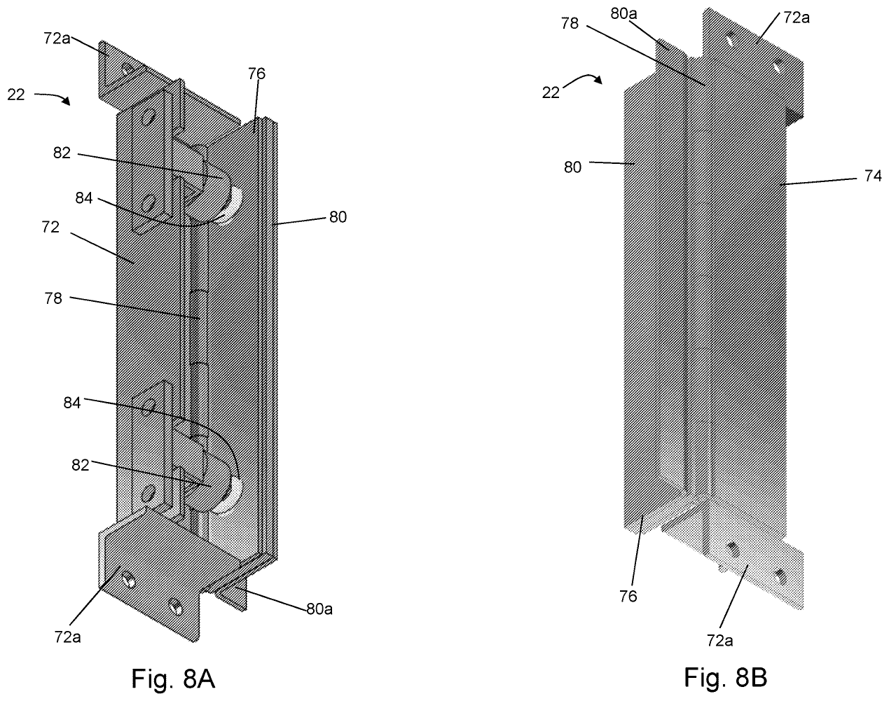

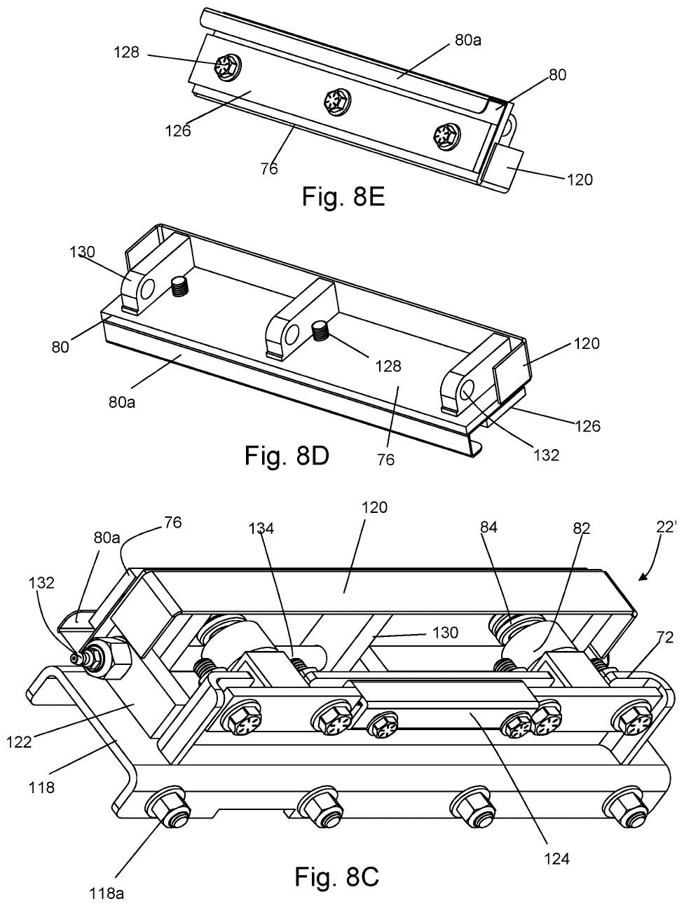

FIGS. 8A and 8B show flip up flange assembly 22 that is bolted to lock side rail 14b of the door by brackets 72a. Assembly 22 comprises a back wall 72 and a bottom wall 74 that are welded to brackets 72a and a front wall 76 that is connected to bottom wall 74 by means of a piano hinge 78. A replaceable piece of sheet metal 80 having a right angle shaped cross section is bolted to the side of front wall 76 that faces jamb 16. The portion 80a of sheet metal 80 that is perpendicular to front wall 76 simulates the overhanging edge of a real door. Piano hinge 78 allows front wall 76 and the sheet metal attached to it to swing forwards and backwards relative to back wall 72 and springs 84 inside spring housings 82 push against front wall 76. When the door 14 of the training apparatus 10 is closed, the springs 84 push portion 80a of sheet metal 80 down against the top of portion 16b of jamb 16. Springs 84 can be easily replaced to provide springs that have different amounts of resistance to compression to provide different levels of difficulty during training.

FIG. 8C shows an embodiment of flip up flange assembly 22′, which is constructed on a piece of U-shaped profile 118. Profile 118 fits over and is bolted to lock side rail 14b of the door 14 by bolts 118a. Assembly 22′ is essentially identical to flip up flange assembly 22 and functions in the same way with changes made for durability of the assembly. Seen in FIG. 8C is back wall 72 and front wall 76. In this embodiment the top side of profile 118 serves as a bottom wall to which the back wall 76 and other components including side walls 122 are welded.

Flip up flange assembly 22′ is essentially comprised of two parts: a rear part that is fixed to the door via profile 118 and a front part that pivots relative to the rear part and flips up from the door jamb 16 during a breaching operation.

The rear part of flip up flange assembly 22′ comprises back wall 72 and spring housings 82 that are bolted to the back wall 72. Springs 84 that push against front wall 76 are shown inside spring housings 82. Also seen in FIG. 8C is a bracket 124 that is used to support and attach a safety cover that is not shown in the figures.

FIG. 8D and FIG. 8E respectively show back and front views of the front part of flip up flange assembly 22′. The front part comprises front wall 76 and a replaceable piece of sheet metal 80 having a right angle shaped cross section 80a. In this embodiment replaceable piece of sheet metal 80 is sandwiched between the front side of front wall 76 and a metal plate 126. Metal plate 126 and sheet metal 80 are bolted to front wall 76 by bolts 128. The purpose of metal plate 126 is to add strength to the sheet metal 80 reducing the frequency with which it has to be replaced. Also seen in these figures is the perpendicular portion 80a of replaceable piece of sheet metal 80 having a right angle shaped cross section that is bolted to the side of front wall 76 that faces jamb 16. On the back side front wall 76 are welded hinge supports 130. A cover 120 is welded to the top edge of the front wall 76 and tops of the hinge supports 130 in order to stabilize the hinge supports 130.

In flip up flange assembly 22′ the hinge that connects the two parts of the assembly and which allows the front part to pivot relative to the rear part is comprised of a hollow cylindrical rod 134 (see FIG. 8C) that passes through holes in the side walls 122 attached to bracket 118 and holes 132 near the bottom of each of the hinge supports 130. A grease fitting 132 at the end of rod 134 allows its interior to be filled with grease and small holes in the wall of the rod at the location of each of the holes in the side walls 122 and holes 132 allow grease to leak out of the interior of rod 134 and reduce friction as the front part of flip up flange assembly 22′ pivots about the rod 134.

As in flip up flange assembly 22 shown in FIGS. 8A and 8B, the portion 80a of sheet metal 80 that is perpendicular to front wall 76 simulates the overhanging edge of a real door. The hinge allows front wall 76 and the sheet metal 80 attached to it to swing forwards and backwards relative to back wall 72 and springs 84. When the door 14 of the training apparatus 10 is closed, the springs 84 push portion 80a of sheet metal 80 down against the top of portion 16a″″ of jamb 16. Springs 84 can be easily replaced to provide springs that have different amounts of resistance to compression to provide different levels of difficulty during training sessions.

FIGS. 9A to 9D are screenshots showing different phases of a breaching procedure carried out using a door breaker tool 58 on training apparatus 10 comprising a flip up flange assembly 20.

FIG. 9A shows the first phase of the breaching procedure. The door 14 is closed against the jamb 16 and springs 84 push front wall 76 of assembly 20 such that sheet metal portion 80a overhangs jamb 16 and is pressed tightly against side 16a″″ of jamb 16. A nut 38 on a sleeve 40 through lock side upright 14b on door 14 and a head 40 of a sleeve through profile 16a of jamb 16 are seen in FIG. 9A indicating the location through which a pin is inserted to simulate at least one deadbolt between door 14 and jamb 16. In this step, dynamic tooth 68 is retracted into the base 66 of the tool 58 and, with the door breaker tool 58 held perpendicular to the plane of the door 14, the trainee forces the edges of the two static teeth 70 and the dynamic tooth 68 at the base 66 of tool 58 between the bottom of sheet metal portion 80a and the top of strip of steel 16b of jamb 16.

FIG. 9B shows the completion of the first phase. At this stage the static teeth 70 and dynamic tooth 68 of the hydraulic door breaker tool 58 are completely inserted between the top of jamb 16 and the bottom of portion 80a of sheet metal 80. In order to allow this and accommodate the thickness of the teeth, front wall 76 of assembly 22 and attached sheet metal 80 pivots around hinge 78 compressing springs 84.

FIG. 9C illustrates what happens after the tool 58 is activated causing dynamic tooth 68 to be pushed away from the base 66 of tool 58. Two actions occur simultaneously when tool 58 is activated. Firstly, dynamic tooth 64 exerts an inwards force on the door jamb 16, which is allowed to move inwards relative to the lock side rail 12b of door frame 12 by the movement of tabs 52 inside cavities 28b at the top and bottom of jamb 16 (see FIGS. 2A, 2B, 4A, and 4B). Secondly static teeth 70 of tool 58 exert an outwards force on sheet metal portion 80a causing it to flip up, i.e. the force exerted by tool 58 overcomes the force exerted by the springs 84 forcing front wall 76 of assembly 22 to pivot backwards lifting portion 80a of the sheet metal off the jamb 16. The combination of these two actions causes the door 12 to begin to swing away from the frame 14 and at the same time exerts a stretching force on the pin acting as a deadbolt.

It is to be noted that, the design of assemblies 22 and 22′ mimic a real door in multiple ways including: 1) the pivot mechanism mimics the movement of a flimsy door with a weak flange which will bend when hydraulic pressure is applied on outward swinging doors; 2) the pivot mechanism will cause the tool to slip if the trainee does not apply the right technique; 3) when the tool slips, the door resets to point zero, mimicking a real door which will slam closed when the tool slips.

FIG. 9D shows the stage at which the dynamic tooth 68 has been completely extended from the base 66 of door breaker tool 58 and the door 14 has been successfully breached. Note how the stretching force has bent pin 46 that simulated a deadbolt and pulled it out of the head 44 of sleeve 22 in the jamb 16.

Sets of holes are provided at various locations on lock side rail 14b of the door that allow the flip up flange assembly 20,22′ to be attached at different heights to allow a trainee to practice breaching the door by inserting the tool at the top, middle, or bottom of door 14.

In a real situation when a door breaker tool 58 of the type shown in these figures is employed to breach a door, the edge of the door is typically damaged beyond repair and the door has to be replaced. Additionally, as the door is separated from the jamb, the teeth of the tool tend to lose their grip on the door and the jamb. Flexing and bending of sheet metal 80 simulates both of these phenomena providing the operator of the tool with realistic training. Using flip up flange assembly 22 with the training apparatus 10, sheet metal piece 80 is easily, quickly, and inexpensively replaced when damaged allowing training apparatus 10 to be used repeatedly for many additional training sessions.

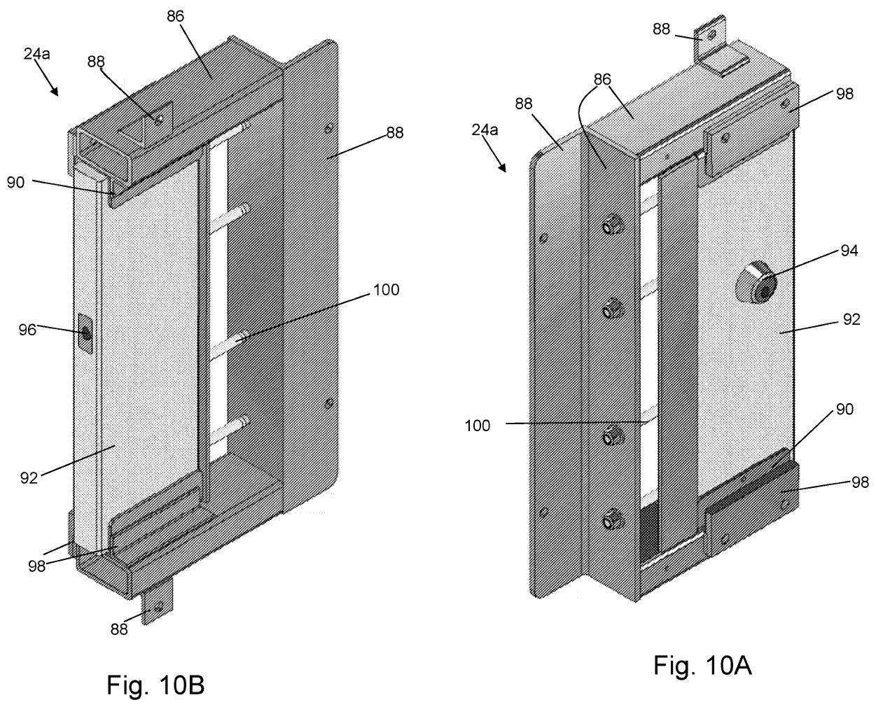

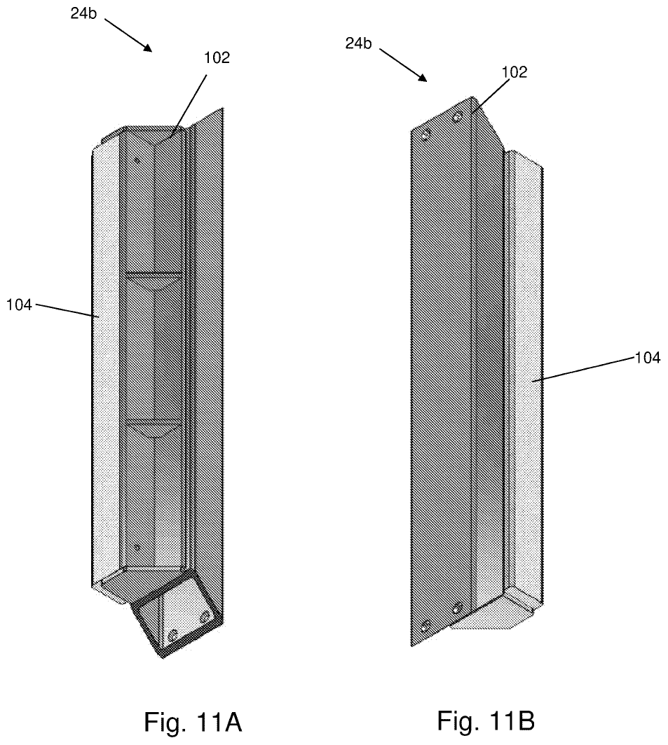

FIGS. 10A and 10B show a cassette subassembly 24a and FIGS. 11A and 11B show a jamb subassembly 24b of zero gap door assembly 24, which is configured to simulate a zero gap door in which lock side rail 14b of door 14 abuts jamb 16 of the door frame 12 and the door 14 is locked to the frame 16 by means of a conventional key turned door bolt.

Cassette subassembly 24a is comprised of frame 86 that can be attached to lock side rail 14b and horizontal profiles 30 of door 14 (see FIG. 3A) by bolts if assembly 24 is not a permanent component of training apparatus 10 or by welding for embodiments in which assembly is a permanent component. FIG. 10A shows cassette subassembly 24a from the side facing the trainee/operator and FIG. 10B shows the opposite side. Structural elements 98 function as guides defining slots at the inside top and inside bottom of frame 86 in which cassette 90 can slide. Cassette 90 is filled with a replaceable wood insert 92 comprised of one or more pieces of wood. A lock body 94 is installed in the wood insert 92 and a face plate 96 is inserted on the edge of the wood insert 92 that faces the jamb 16. Turning a key in lock body 94 causes a lock bolt to extend outwards through face plate 96 or retract back into the wood insert 92. Subassembly 24a comprises multiple springs 100 that are arranged to push the cassette 90 towards the jamb 16 and to provide resistance as the cassette 90 is forced to slide into the frame 86 away from the jamb during a breaching exercise. Four springs 100 are shown in the figures but more or less can be present in different embodiments. Springs 100 can be easily replaced to provide springs that have different amounts of resistance to compression to provide different levels of difficulty during training.

Subassembly 24b is shown in FIGS. 11A and 11B. Subassembly 24b comprises a frame 102 configured to be attached to side 16a″ of profile 16a of jamb 16 (see FIG. 4A) and to support a replaceable wood insert 104. Subassembly 24b is attached to jamb 16 by bolts if assembly 24 is not a permanent component of training apparatus 10 or by welding for embodiments in which assembly 24 is a permanent component. Wood insert 104 fits into frame 102 such that one edge of wood insert 104 faces wood insert 92 of subassembly 24a. This edge of wood insert 104 comprises a strike plate and hole (not shown in the figures) that receive the lock bolt that extends from the face plate 96 to lock the two subassemblies together.

An embodiment of training apparatus 10 is configured with bolt holes that enable zero gap door assembly 24 to be mounted on either side of door 14. Bolting cassette subassembly 24a and subassembly 24b to the opposite sides of door 14 and jamb 16 from the side shown in, for example, FIG. 1A means that door assembly 24 will be facing a trainee who approaches apparatus 10 from the side of the gate 20. This configuration of training assembly 10 allows for a more complex training exercise in which the trainee must first successfully breach the gate 20, for example with a shotgun, cutting tool or a hydraulic breaching tool, and then breach the door 14, for example using a hydraulic breaching tool.

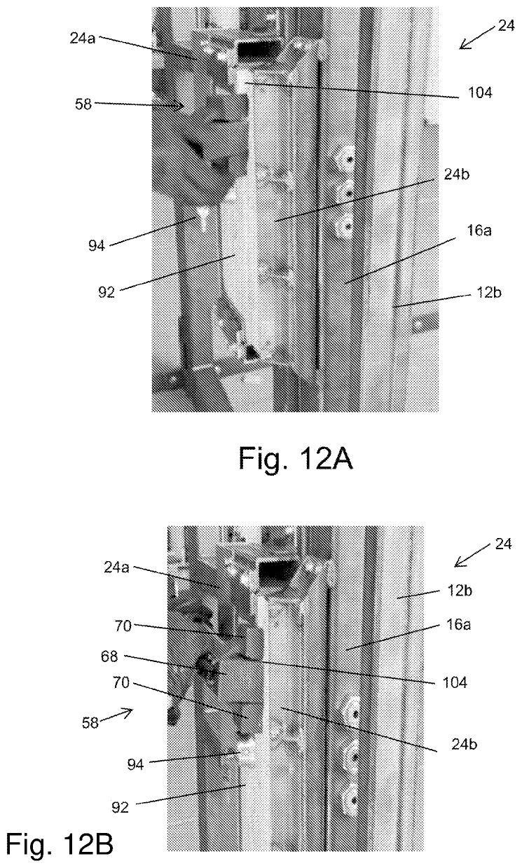

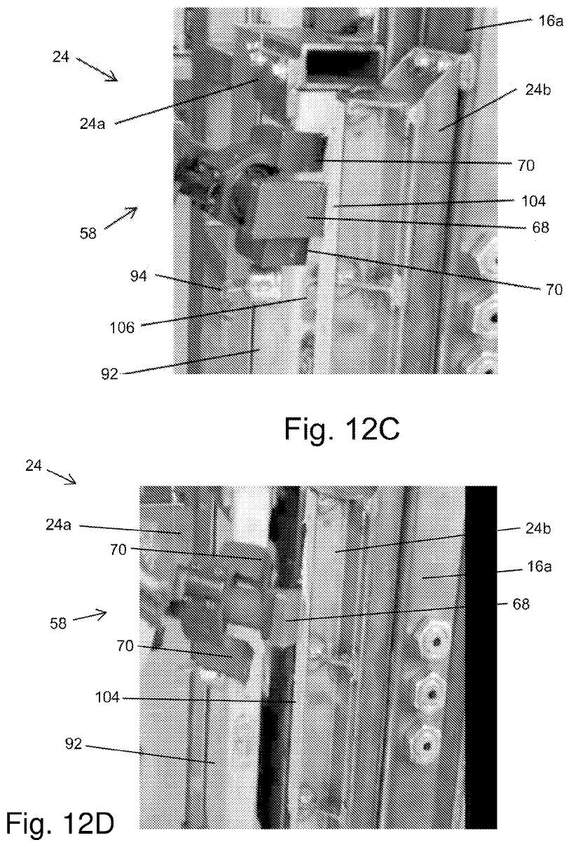

FIGS. 12A to 12D are screenshots showing different phases of a breaching procedure carried out using a door breaker tool 58 on training apparatus 10 comprising zero gap door assembly 24.

FIG. 12A shows the first phase of the breaching procedure. The door 14 is locked to the jamb 16 by rotating a key in lock body 94 on the wood insert 92 of subassembly 24a that is attached to the door. Rotating the key extends a lock bolt 106 (see FIG. 12C) from face plate 96 on the wood insert 92 into a strike plate (not visible in the figures) in the side of piece of wood 104 in frame 102 of subassembly 24b attached to profile 16b of profile 16. In this step, dynamic tooth 68 is retracted against the base 66 of the tool 58. With door breaker tool 58 held parallel to the plane of the door the edges of the three teeth 68 and 70 at the base 66 of tool 58 are forced between the edge of wood insert 92 in cassette 90 od subassembly 24a that simulates the door edge and the wood insert 104 in subassembly 24b that simulates the edge of jamb 16.

FIG. 12B shows the completion of the first phase. At this stage the dynamic tooth 68 and static teeth 70 of the hydraulic door breaker tool 58 are inserted between wood insert 92 in cassette 90 and wood insert 105 in frame 102 on the jamb.

Note that with assembly 24 the hydraulic door breaker tool 58 is held parallel to the door in order to force the door sideward relative to the door jam. This is opposed to assembly 22 (see FIGS. 9A-10B) in which the hydraulic door breaker tool 58 is held perpendicular to the door in order to force the door to swing open away from the door jam.

In FIG. 12C the hydraulic door breaker tool 58 is activated extending the dynamic tooth 68, which pushes against piece of wood insert 104 while static teeth 70 exert a counter force on the wood insert 92 in cassette 90. The force exerted by dynamic tooth 68 causes jamb 16 to move sideward away from the cassette 90 within cavity 28b at the top and bottom of jamb 16 (see FIG. 2A). At the same time the force exerted by static teeth 70 pushes the cassette 90 compressing springs 100. The combination of movement of the jamb 16 and compression of the springs 100 causes the cassette 90 to begin to move away from profile 16a of the jamb 16 and allows lock bolt 106 to begin to slip out of the strike plate on wood insert 104 in the frame 102 of subassembly 24b.

In FIG. 12D the dynamic tooth 68 has been extended to the point where the jamb 16 has moved in one direction and the compression of springs 100 has allowed the cassette 60 to move in the opposite direction until the distance between subassemblies 24a and 24b is large enough that lock bolt 106 slips completely out of the strike plate and the door 14 can be swung open away from the jamb.

When, in a real scenario, a hydraulic door breaker tool 58 is employed to breach a door the edge of the door and jamb are typically damaged beyond repair and have to be replaced. Using assembly 24 with the training apparatus 10, the wooden inserts 92 and 104 are easily, quickly, and inexpensively replaced when damaged allowing training apparatus 10 to be used repeatedly for an unlimited number of additional training sessions while maintaining the exact same breaching technic used on real doors.

Although embodiments of the invention have been described by way of illustration, it will be understood that the invention may be carried out with many variations, modifications, and adaptations, without exceeding the scope of the claims.

1. A training apparatus configured for training personnel in the skills necessary for breaching doors using breaching tools, the training apparatus comprising: a door and a door frame wherein:
a. the door is comprised of two horizontal lengths and two vertical lengths of hollow steel profile welded at their corners to form a rectangle, wherein the profiles of the door are identified as follows: hinge side rail, lock side rail, bottom rail, and top rail;
b. the door frame is comprised of two horizontal and two vertical lengths of hollow steel profile welded at their corners to form a rectangle, wherein the profiles of the door frame are identified as follows: hinge side upright, lock side upright, sill, and header;
c. the hinge side rail of the door is connected to the hinge side upright of the door fame by hinges allowing the door to swing open or close inside the frame;
the training apparatus is characterized in that the door frame comprises an additional upright profile that functions as the door jamb located between the lock side upright of the door frame and the lock side rail of the door; wherein the door jamb is supported by the door frame but not fixed directly to the door frame at either the header or the sill and the top and bottom of the door jamb are free to move sideways and forward and backward within confined spaces attached respectively to the header and the sill of the door frame in order to allow the door jamb to move away from the lock side rail of the door during a breaching exercise.

2. The training apparatus of claim 1, wherein:
a) the jamb comprises:
i) a projecting tab or pin at the top and bottom; and
ii) a bracket below the tab or pin at the top and bottom;
b) the door frame comprises:
i) a box attached to the header and a box attached to the sill;
ii) a recess in each box;
iii) spring holders attached near the top and bottom of the lock side upright; and
iv) springs in the spring holders;
c) the projecting tabs or pins at the top and bottom of the jamb fit loosely into the recesses, thereby allowing the top and bottom of the jamb to move sideways and forward and backward, within the recesses and the springs butt against the brackets to push the jamb against the lock side rail of the door and to maintain counter pressure against the lock side rail and a breaching tool when attempting to move the jamb away from the lock side rail of the door during a breaching exercise, wherein the springs can be easily replaced to provide springs that have different amounts of resistance to compression to provide different levels of difficulty during training.

3. The training apparatus of claim 1 comprising multiple holes drilled through the jamb and corresponding holes drilled through the lock side rail of the door, wherein the holes are configured to allow pins to be inserted that simulate multiple locking locations.

4. The training apparatus of claim 3, comprising replaceable sleeves in at least one of the holes through the jamb and the lock side rail of the door.

5. The training apparatus of claim 4, wherein the replaceable sleeves have hexagonal heads.

6. The training apparatus of claim 1 comprising at least one of the following training assemblies: a) a gate; b) a flip up flange assembly; and c) a zero gap door assembly.

7. The training apparatus of claim 6, wherein the gate is configured to train personnel to use various types of tools designed for cutting metal bars, chains, chain link fences, padlocks, as well as breaching shotguns and hydraulic breaching tools.

8. The training apparatus of claim 6 wherein the flip up flange assembly is configured for training in the use of a breaching tool for breaching doors that comprise a flange that covers a gap between the door and the jamb.

9. The training apparatus of claim 8, wherein the flip up flange assembly comprises:
a) a replaceable piece of sheet metal having a portion that simulates the edge of a real door that overhangs the jamb; and
b) springs that exert a force that pushes the portion of replaceable sheet metal firmly against the top of the jamb, wherein the springs can be easily replaced to provide springs that have different amounts of resistance to compression to provide different levels of difficulty during training.

10. The training apparatus of claim 9, wherein the replaceable piece of sheet metal is sandwiched between a metal plate and front side of front wall of the flip up flange assembly and the metal plate and sheet metal are bolted to the front wall.

11. The training apparatus of claim 9, wherein during a breaching exercise the breaching tool is inserted between the bottom of the portion of the sheet metal and the top of the jamb and during the procedure the breaching tool overcomes the force exerted by the springs, thereby forcing the portion of sheet metal to pivot upwards separating the door from the jamb.

12. The training apparatus of claim 6, wherein the zero gap door assembly is configured for training in the use of a breaching tool for breaching a door in which abuts the frame and is locked to the frame by means of a key activated lock bolt.

13. The training apparatus of claim 12, wherein the zero gap door assembly comprises:
a) a cassette subassembly; and
b) a jamb subassembly.

14. The training apparatus of claim 13, wherein:
a) the cassette subassembly comprises:
i) a frame configured to be attached to the lock side rail of the door;
ii) a cassette filled with a wood insert comprised of one or more pieces of wood;
iii) a lock body installed in the wood insert;
iv) a face plate inserted on the edge of the wood insert that faces the jamb;
v) a lock bolt configured to extend outwards through the face plate or retract back into the wood insert;
vi) multiple springs configured to push the cassette towards the jamb and to provide resistance as the cassette is forced to slide into the frame away from the jamb during a breaching exercise, wherein the springs can be easily replaced to provide springs that have different amounts of resistance to compression to provide different levels of difficulty during training;
b) the jamb subassembly comprises:
i) a frame configured to be attached to a side of the jamb;
ii) a wood insert configured to fit into the frame such that one edge of the wood insert faces the face plate on the wood insert in the cassette subassembly;
iii) a strike plate and hole configured to receive the lock bolt that extends from the face plate of the cassette subassembly to lock the two subassemblies together.

15. The training apparatus of claim 14, wherein the wood inserts in at least one of the cassette subassembly or the jamb subassembly are replaceable if damaged.

16. The training apparatus of claim 14, wherein during a breaching training exercise, with the two subassemblies locked together, a breaching tool is inserted between the wood insert in the cassette subassembly and the jamb assembly and activated, whereupon the force exerted by the breaching tool overcomes the force exerted by the springs thereby compressing the springs and pushing the cassette into the frame until the lock bolt is pulled out of the strike plate allowing the door to be separated from the jamb.

17. The training apparatus of claim 1 comprising a support structure configured to minimize interference with the activities of trainees during a breaching training session.

18. The training apparatus of claim 6, wherein the gate comprises a wood plank configured to allow the training apparatus to be used for training in ballistic breaching.

19. The training apparatus of claim 1, wherein the door comprises a metal plate configured to allow the training apparatus to be used for training in mechanical or explosive breaching.
